(19) United States
(12) Patent Application Publication
(10) Pub. No.: US 2022/0134928 A1
(43) Pub. Date: May 5, 2022

(54) SEAT MASSAGE DEVICE WITH SENSOR DEVICE

(71) Applicant: Brose Fahrzeugteile SE & Co. Kommanditgesellschaft, Bamberg, Bamberg (DE)

(72) Inventor: Alexander MÜLLER, Bischberg (DE)

(73) Assignee: Brose Fahrzeugteile SE & Co. Kommanditgesellschaft, Bamberg, Bamberg (DE)

(21) Appl. No.: 17/433,763

(22) PCT Filed: Feb. 26, 2020
(86) PCT No.: PCT/EP2020/055029

§ 371 Date: Aug. 25, 2021

(30) Foreign Application Priority Data
Feb. 26, 2019 (DE) 10 2019 104 858.3

(51) Int. Cl. B60N 2/90; B60N 2/00; A61H 23/00; A61H 9/00

(52) U.S. Cl. CPC B60N 2/976; B60N 2/002; B60N 2002/0268; A61H 9/0092; A61H 23/006; A61H 23/004

(57) ABSTRACT

A massage device for use in a seat including at least one massage head, which is configured to provide a massage function in at least one sub-region of a seat, and a sensor device, which is configured to detect a contact of the seat by a user in the at least one sub-region of the seat. The massage device is configured to actuate the massage head at least in part depending on a sensor signal which is generated by the sensor device and which indicates a contact by the user in the at least one sub-region of the seat.

### CROSS-REFERENCE TO RELATED APPLICATIONS

This application is the U.S. National Phase of PCT Application No. PCT/EP2020/055029 filed on Feb. 26, 2020, which claims priority to German Patent Application No. DE 10 2019 104 858.3, filed on Feb. 26, 2019, the disclosures of which are hereby incorporated in their entirety by reference herein.

### TECHNICAL FIELD

The present disclosure relates generally to the field of massage devices including massage devices disposed in a seat such as a vehicle seat.

### BACKGROUND

Various techniques for providing a massage function in a vehicle seat are known. With some of these techniques, rotating shafts are mounted in the vehicle seat behind the seat cushion and are equipped with massage lobes. Other techniques provide, for example, massage rams arranged in the seat in a grid-like fashion or inflatable so-called pneumatic bladders, which, when actuated, provide a massaging pressure in the corresponding region of the seat. Massage systems based on massage rams or pneumatic bladders are often designed, when actuated, to follow a predefined path of travel corresponding to a massage movement.

### SUMMARY

According to a first embodiment, a massage device for use in a seat is provided. The massage device may include at least one massage head, which is configured to provide a massage function in at least one sub-region of a seat, and a sensor device, which is configured to detect a contact of the seat by a user in the at least one sub-region of the seat. The massage device is configured to actuate the massage head at least in part depending on a sensor signal which is generated by means of the sensor device and which indicates a contact by the user in the at least one sub-region of the seat.

The sensor signal may indicate at least one body parameter of the user. The body parameter in this case may include a body height and/or a body weight of the user. In addition, the massage device may be configured to actuate the massage head depending on the body parameter.

The massage head may include a massage ram and/or a pneumatic bladder.

The sensor device may include at least one sensor unit, which is arranged on the massage head. The sensor device may be configured to detect a pressure between the massage head and a user of the seat in the at least one sub-region. The sensor device may include a capacitive pressure sensor. Additionally or alternatively, the sensor device may include further or other sensor types, which are suitable for detecting a contact and/or a body parameter of a user in the sub-region of the seat.

The massage head may include a massage ram with a spring element. The massage device may also include a return element with an electromechanical actuator, which is configured to change a form of the spring element with respect to a contact face of the seat. In this case, the sensor device may be arranged on the spring element, and the spring element may include electrically conductive material and may be part of an electrical connection between the sensor device and a power source provided for operation of the sensor device.

At least one massage head may be configured to provide a massage function in a plurality of sub-regions of the seat. In this case, the sensor device may be configured to detect a contact of the seat by the user in any of the plurality of sub-regions. The massage device may also be configured in this case to actuate the massage head differently in different sub-regions of the plurality of sub-regions of the seat at least in part depending on at least one sensor signal. In this case, the sensor signal may be generated by means of the sensor device and may indicate a different contact by the user in the different sub-regions of the seat.

Additionally or alternatively, the massage device may include a plurality of massage heads which are assigned to different sub-regions of the seat. Here as well, the sensor device may be configured to detect a contact of the seat by the user in any of the different sub-regions. Furthermore, the massage device may be configured to actuate different massage heads differently at least in part depending on at least one sensor signal which is generated by means of the sensor device and which indicates a different contact by the user in different sub-regions of the seat to which the different massage heads are assigned.

In another embodiment, a massage system for a seat is described. The massage system may include a massage device of the kind presented here and a control unit. The control unit is configured to receive a sensor signal from the sensor device, to generate a control signal to actuate the at least one massage head of the massage device at least in part depending on the sensor signal, and to output the control signal to the at least one massage head.

The control unit may also be configured to determine a control program at least in part on the basis of the sensor signal and to generate the control signal according to the control program.

The sensor signal may indicate at least one body parameter of the user. In addition, the control program may be determined according to the body parameter. The body parameter may include a body height and/or a body weight of the user.

In one or more embodiments, a vehicle seat is described. The vehicle seat may include a massage device and/or a massage system in each case of the kind presented here.

In one or more embodiments, a motor vehicle is described. The motor vehicle may include a massage device, a massage system and/or a vehicle seat in each case of the kind presented here.

In one or more embodiments, a method for operating a massage device which is arranged in a seat is described. The method may include detecting, by means of a sensor device of the massage device and in any of a plurality of sub-regions of the seat, whether a contact of the seat by a user in the particular sub-region is present. The method additionally may include generating, by means of a control unit and at least in part depending on the detection of a contact in any of the sub-regions, a control signal to actuate at least one massage head of the massage device, in such a way that it is possible to actuate the massage heads assigned to the different sub-regions differently in different sub-regions of the seat. The method also may include outputting the control signal to the at least one massage head by means of the control unit.

Further details, objectives and preferences of the invention will become clear from the drawings and the detailed description.

### BRIEF DESCRIPTION OF THE DRAWINGS

In the drawings:

FIG. 1 shows a schematic depiction of a massage device according to an exemplary embodiment;

FIG. 2 shows a schematic depiction of a massage device according to a further exemplary embodiment;

FIG. 3 shows a schematic depiction of a massage system according to an exemplary embodiment; and

FIG. 4 shows a flow diagram of a method for operating a massage device according to an exemplary embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

With the known techniques for providing a massage function, including those with massage rams or pneumatic bladders, massage patterns are often reproduced at a predefined intensity and speed. For example, rams or pneumatic bladders are extended by a predetermined path and are retracted again to the rest position. This may result in disadvantages, specifically that the massage intensity and massage effect perceived by a user often varies greatly as a result of different body height, different body weight, and/or different seating position. At the same time, fixed massage patterns are additionally often found to be robot-like by users. Additionally, for users who have a relatively short body height, some massage heads, for example such as rams or pneumatic bladders arranged in the edge region of the seat, might not have anything to work on, thus reducing the efficiency of the massage system.

A technique that mitigates or avoids the aforementioned disadvantages is therefore desirable.

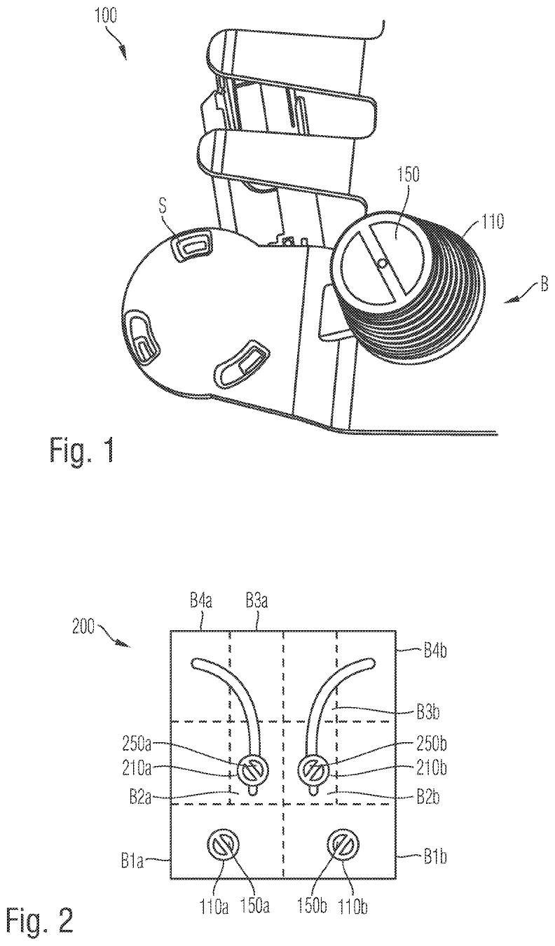

FIG. 1 shows schematically and in an exemplary manner a massage device 100 according to an exemplary embodiment. The massage device 100 may include a massage head 110 and a sensor device 150. The massage device 100 is intended to provide a massage function in a seat, such as a vehicle seat. In the shown example, the massage device 100 is mounted on a seat structure S of a backrest of a vehicle seat. The massage device 100 is arranged here in such a way that it provides a massage function in a sub-region B of the seat.

The massage head 110 is, for example, a massage rod or a pneumatic bladder. The massage head 110, when actuated, causes a massage pressure to be exerted, in some examples associated with a lateral movement or deformation of the massage head 110, for example to generate a massage movement in an axial and lateral direction of the massage head 110 simultaneously.

The sensor device 150 is configured to detect a contact of the seat in a sub-region B by a user of the seat. In some examples, the sensor device 150 to this end may include a pressure sensor. The sensor device 150 is in this case arranged for example behind a cushioning of the seat in the sub-region B and serves to detect a pressure caused by a body weight of the user that loads the cushion in the sub-region B. In the shown example, the sensor device 150 is arranged on the massage head 110, such as on an upper side of the massage head 110.

The sensor device 150 may include, for example, a capacitive pressure sensor. The sensor device 150 in this case makes it possible to determine a pressure between the massage head 110 and the body of the user or a cushion of the seat arranged between the user and the massage head 110 due to a change in an electrical capacitance within the sensor device 150.

The sensor device 150 is additionally configured to output a sensor signal which indicates the presence of a contact of the seat by the user in the sub-region B. In some examples, the sensor signal also indicates one or more parameters of the contact, for example the magnitude of a detected pressure of the contact. Such a parameter makes it possible, for example, to determine a body weight, a body height, and/or a seating position of the user.

The massage device 100, by means of the sensor device 150, is able to detect a contact and, in some examples, also one or more further parameters of the contact, for example such as a pressure, in the sub-region B of a seat and to generate and to output a corresponding sensor signal. Based on the sensor signal, it is possible to actuate the massage head 110 in accordance with the detected contact. For example, it is possible, in the sub-region B of the seat, to provide by means of the massage head 110 a massage function that corresponds to a contact of the seat in the sub-region B by the user. For example, the massage head 110 may be activated depending on whether a contact of the seat in the sub-region B is present. In this way, for example with a passenger of relatively short body height or having a seating position in which there is no contact with the seat in the sub-region B, the massage head 110 that is of no use for the passenger may be prevented from being activated and having nothing to work on. An unnecessary activation of the massage head 110 may thus be avoided, which corresponds to an increased efficiency of the massage device 100.

In further examples, the detection of a contact parameter, for example such as a contact pressure, allows the massage head 110 to be operated additionally depending on such a parameter. For example, a contact pressure indicates a body weight and/or a certain body part of the user resting against the sub-region B. The massage head 110 may be operated here by suitable control in such a way that a resultant massage function is adapted to the body weight and/or the resting body part. For example, in the case of a relatively high pressure of the contact in the sub-region B, the massage head 110 may be operated such that a more intense massage function is provided. In other examples of the massage device 100, further or other contact parameters are detectable by means of the sensor device 150 and/or the massage head 110 may be operated in a manner other than that described, depending on such parameters.

In the shown example, the sensor device 150 is arranged on an upper side of the massage head 110. This is advantageous, for example, since it allows contact directly in the effective region of the massage head 110 to be directly determined. An adjustment of the massage function of the massage head 110 to the contact is thus possible with a high level of accuracy. In further examples, the sensor device 150, by contrast, is not arranged directly on the massage head 110. In these examples, the sensor device 150, however, is likewise configured such that it is possible to determine contact, at least for a sub-region B to which the massage head 110 is assigned, with sufficient spatial accuracy, as required.

The mounting of the sensor device 150 on the massage head 110 is additionally advantageous in some examples of the massage device 100 in which the massage head 110 provides a massage function in different sub-regions B of a seat by lateral movement or deformation. In this case, the arrangement of the sensor device 150 on the massage head 110 is suitable for detecting a contact in any of the plurality of sub-regions B. An operation of the massage head 110, for example in respect of a massage intensity, may be adapted here in any of the sub-regions depending on the detection of a contact in the corresponding sub-region B. In this way as well, an unnecessary massage function in sub-regions B which have no contact by a user may be avoided or reduced. In addition, the detection of a contact and/or further contact parameters in a plurality of sub-regions makes it possible to create more accurately a contact profile or to determine more precisely body parameters of the user, for example such as a body height, a body weight, and/or a seating position. This in turn makes it possible to adapt more expediently the massage function of the massage head 110 in each of the different sub-regions B.

In some examples, the massage head 110 may include a massage ram with a spring element. The form of the spring element in respect of a contact face of the seat is changeable here by means of a return element, which may include an electromechanical actuator. For example, the spring element may be transferred by means of the return element into a tensioned state. For this purpose, the return element in some examples may include a pull cable, which is connected to the spring element and which may be actuated by the electromechanical actuator in order to deform the spring element elastically. As the spring element transitions from its tensioned state into its relaxed state, it exerts a massage pressure on the contact face of the seat. In some of these examples, the sensor device 150 is arranged on the spring element and is electrically conductively connected thereto. The spring element in this case may include electrically conductive material and is part of an electrical connection between the sensor device 150 and a power source provided for operation of the sensor device 150.

In the shown example, the massage device 100, as described, is arranged in a backrest of the seat. In further examples, the massage device 100 is arranged in the region of a sitting surface of the seat. In some examples, the massage device 100, by means of the sensor device 150, is additionally suitable in this case for use for detecting whether a seat is occupied.

FIG. 2 shows schematically and by way of example a massage device 200 according to a further example. The massage device 200 may include a plurality of massage heads 110a, 110b, 210a, 210b. The massage heads 110a, 110b, 210a, 210b are assigned here to different sub-regions B1a, B1b, B2a, B2b, B3a, B3b, B4a, B4b of the massage device 200, wherein the sub-regions correspond for example to corresponding sub-regions of a seat. That which has been stated in conjunction with the massage device 100 from FIG. 1 additionally applies correspondingly for the massage heads 110a, 110b, 210a, 210b, unless stated otherwise in the following.

The massage device 200 likewise may include a sensor device for detecting a contact, of a seat, in any of the sub-regions B1a, B1b, B2a, B2b, B3a, B3b, B4a, B4b. In the shown example, a corresponding sensor unit 150a, 150b, 250a, 250b is to this end arranged on each of the massage heads 110a, 110b, 210a, 210b, similarly to the example from FIG. 1. By contrast, in other examples a different sensor device is provided, in order to detect a contact and/or further contact parameters in the different sub-regions, as described previously.

The massage heads 110a, 110b are assigned to only one sub-region B1a, B1b each, in order to provide a massage function in the relevant sub-region. By contrast, the massage heads 210a, 210b are assigned to a plurality of sub-regions B2a, B2b, B3a, B3b, B4a, B4b each and provide a massage function in any of these sub-regions, as described in conjunction with some examples from FIG. 1. In the example from FIG. 2, the massage heads 210a, 210b are for this purpose shown to be movable between a plurality of sub-regions. A path of movement of the massage head 210a runs in this case into the sub-regions B2a, B3a and B4a. By contrast, a path of movement of the massage head 210b runs into the sub-regions B2b, B3b and B4b. In further examples, the massage heads 210a, 210b are secured in a stationary manner and are configured to provide a massage function in the corresponding plurality of sub-regions by way of a deformation of the massage head 210a, 210b during operation.

As described in conjunction with FIG. 1, the detection of a contact and, optionally, further contact parameters in a plurality of sub-regions of a seat makes it possible to determine a body height, a weight and/or a seating position of a user of the seat in an improved manner. Besides the mere avoidance of an ineffective activation of massage heads in non-contacted regions of the seat, a contact profile determined in this way over a plurality of sub-regions makes it possible to adapt a massage pattern to different body properties of the user. For example, an overall intensity of the massage function may be adapted to the weight of the user, by actuating each of the massage heads 110a, 110b, 210a, 210b correspondingly. In addition, massage patterns, inclusive of a local massage pressure or a lateral massage movement, may be adapted to the contours and proportions of the body of the user. A massage effect for the user may thus be improved.

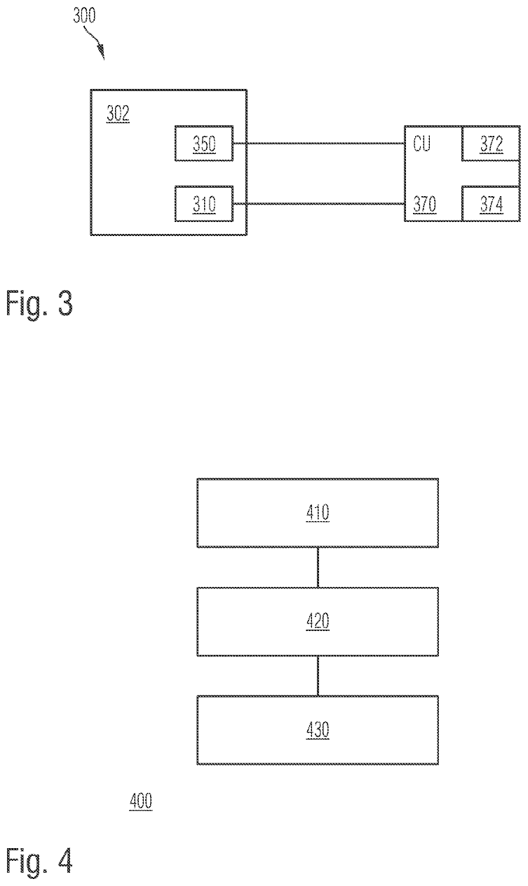

FIG. 3 shows schematically and by way of example a massage system 300 for a seat, such as a vehicle seat. The massage system 300 may include a massage device 302 with one or more massage heads 310, which are configured to provide a massage function in corresponding sub-regions of a seat, and also a sensor device 350 for detecting a contact in each of the sub-regions of the seat. That stated previously in conjunction with the massage devices 100, 200 applies correspondingly for the massage device 302.

The massage system 300 additionally may include a control unit 370, which is operatively connected to the massage device 302. In this case, the control unit 370 receives one or more signals from the sensor device 350 and outputs a control signal to the one or more measuring heads 310. The control unit 370 may include, in the shown example, a processor unit 372 and a memory device 374, which is communicatively connected to the processor unit 372.

In the massage system 300, the control unit 370 is configured by means of the processor unit 372 such that it generates a control signal for actuating the massage heads 310 on the basis of one or more sensor signals received from the sensor device 350. The control unit 370 is configured here, for example, to determine the control signal in accordance with a contact in any of a plurality of sub-regions of a seat in which the massage device 302 is arranged. To this end, in some examples one or more associations between one or more sensor signals and, in each case, corresponding control signals are stored in the memory device 374. After receipt of one or more sensor signals, the processor unit 372 for example accesses the memory device 374 in order to compare the received signal with stored possible sensor signals and, in the event of a match of key signal properties, to read out one or more, in each case associated, control signals and to output same in order to actuate the massage heads 310.

In further examples, the control unit 370 is configured to determine or to generate, in a manner different from that described previously, a control signal for actuating the massage heads 310 depending on one or more received sensor signals, which indicate the presence of a contact in the different sub-regions of the seat. In a simple example, the control unit 370 generates a control signal, which causes a predetermined activation of precisely those massage heads 310 in the sub-region of which a contact by a user has been detected. In further examples, the control signal is such that the massage heads 310 are actuated under consideration of further contact properties and/or contact parameters, as described previously.

In some examples of the massage system 300, the massage system 300 is arranged fully in a vehicle seat. In further examples, the massage device 302 of the massage system 300 is arranged in a seat, such as a vehicle seat, and the control unit 370 is arranged outside the seat, for example as part of a control unit of a motor vehicle in which the seat is located.

FIG. 4 shows a flow diagram of a method 400 for operating a massage device that is arranged in a seat. The method 400 is suitable, for example, for operating a massage device as described previously. The method 400 may include detecting, by means of a sensor device of the massage device and in any of a plurality of sub-regions of a seat, whether a contact of the seat by a user in the particular sub-region is present, step 410. The method 400 additionally may include generating, by means of a control unit and at least in part depending on the detection of a contact in any of the sub-regions, a control signal for actuating at least one massage head of the massage device, in such a way that the massage head assigned to the particular sub-region may be actuated differently in different sub-regions of the seat, step 420. The method 400 additionally may include outputting, by means of the control unit, the control signal to the at least one massage head, step 430.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

The following is a list of reference numbers shown in the Figures. However, it should be understood that the use of these terms is for illustrative purposes only with respect to one embodiment. And, use of reference numbers correlating a certain term that is both illustrated in the Figures and present in the claims is not intended to limit the claims to only cover the illustrated embodiment.

List of reference signs:

| | |
|---|---|
| 100, 200, 302 | massage device |
| 110, 110a, 110b, 210a, | massage head |
| 210b, 310 | |
| 150, 150a, 150b, 250a, | sensor device |
| 250b, 350 | |
| 300 | massage system |
| 370 | control unit |
| 372 | processor unit |
| 374 | memory device |
| 400 | method |
| 410, 420, 430 | method steps |
| B, B1a, B1b, B2a, B2b, | sub-region |
| B3a, B3b, B4a, B4b | |
| S | seat structure |

1. A massage device, for use in a seat, the massage device comprising:
a massage head configured to provide a massage function in at least one sub-region of the seat; and
a sensor device configured to detect a contact of the seat by a user in the at least one sub-region,
wherein the massage head is configured to be actuated based on at least in part on a sensor signal generated by the sensor device indicative of the contact by the user in the at least one sub-region of the seat.

2. The massage device of claim 1, wherein the massage head includes a massage ram and/or a pneumatic bladder.

3. The massage device of claim 1, wherein the sensor device includes at least one sensor unit arranged on the massage head.

4. The massage device of claim 1, wherein the massage head includes:
a massage ram provided with a spring element, and
a return element provided with an electromechanical actuator, configured to change a form of the spring element with respect of a contact face of the seat, wherein the sensor device is disposed on the spring element and the spring element includes an electrically conductive material and forms a portion of an electrical connection between the sensor device and a power source configured to provide power to the sensor device for operation of the sensor device.

5. The massage device of claim 1, wherein the sensor device is configured to detect a pressure between the massage head and the user.

6. The massage device of claim 1, wherein the sensor device includes a capacitive pressure sensor.

7. The massage device of claim 1, further comprising:
a number of massage heads including the massage head, wherein the number of massage heads are each configured to provide a massage function in a plurality of sub-regions of the seat, and a number of sensor devices are each configured to detect the contact of the seat by the user in any of the plurality of sub-regions.

8. The massage device of claim 7, wherein each of the number of massage heads are configured to be actuated differently in different sub-regions of the plurality of sub-regions based at least in part on at least one sensor signal generated by the number of sensor devices indicative of a different contact by the user in the different sub-regions.

9. The massage device of claim 1, further comprising:
a plurality of massage heads, including the massage head, disposed in different sub-regions of the seat, and a plurality of sensor devices, including the sensor device, each configured to detect a contact of the seat by the user in any of the different sub-regions.

10. The massage device of claim 9, wherein each of massage heads of the plurality of massage heads are configured to be actuated differently based at least in part on at least one sensor signal generated by means of at least one sensor device of the plurality of sensor devices, wherein the at least one sensor signal is indicative of a different contact by the user in the different sub-regions.

11. A massage system for use in a seat, the massage system comprising:
a control unit configured to, responsive to receiving a sensor signal from a sensor device configured to detect a contact of the seat by a user in a sub-region of the seat,
generate a control signal to actuate a massage head based at least in part on the sensor signal, and
output a control signal to the massage head.

12. The massage device of claim 11, wherein the control unit is further configured to determine a control program based at least in part on the sensor signal, wherein the control signal is based at least in part on the control program.

13. The massage device of claim 10, wherein the sensor signal is indicative of at least one body parameter of the user, and the control program is determined based on the at least one body parameter.

14. The massage system of claim 13, wherein the at least one body parameter includes a body height and/or a body weight of the user.

15. A vehicle seat comprising:
a massage head configured to provide a massage function in at least one sub-region of the vehicle seat; and
a sensor device configured to detect a contact of the vehicle seat by a user in the at least one sub-region, wherein the massage head is configured to be actuated based on at least in part on a sensor signal generated by the sensor device indicative of the contact by the user in the at least one sub-region.

16. (canceled)

17. A method of operating a massage device arranged in a seat, the method comprising:
detecting, by a sensor device, disposed any of a plurality of sub-regions of the seat, a contact of the seat by a user in a sub-region of the plurality of sub-regions;
generating, by a control unit, a control signal to actuate a number of massage heads disposed in different sub-regions of the plurality of sub-regions based at least in part on the detecting step; and
outputting, by the control unit, the control signal to the number of massage heads to actuate massage heads disposed in the different sub-regions differently.

18. The vehicle seat of claim 15, wherein the sensor device is disposed on the massage head.

19. The vehicle seat of claim 15, further comprising:
a second massage head disposed in another sub-region of the vehicle seat;
a second sensor device fixed to the second massage head;
a controller configured to, responsive to receiving a first sensor signal from the sensor device and a second sensor signal from the second sensor device, generate a control signal to actuate the massage head based at least in part on the first sensor signal, and to actuate the second massage head based at least in part on the second sensor signal.

20. The vehicle seat of claim 19, wherein the control signal is configured to operate the massage head at a first massage intensity and operate the second massage head at a second massage intensity, wherein the first massage intensity is greater than the second massage intensity.
